(19) United States
(12) Patent Application Publication
(10) Pub. No.: US 2004/0018905 A1
(43) Pub. Date: Jan. 29, 2004

(54) Roller chain

(76) Inventors: Isamu Okabe, Osaka (JP); Takashi Tohara, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/444,302

(22) Filed: May 23, 2003

(30) Foreign Application Priority Data
Jul. 23, 2002 (JP) 2002-213944

(51) Int. Cl. F16G 13/02

(52) U.S. Cl. 474/231

(57) ABSTRACT

In a roller chain having cylindrical pins rotatably fitting into bushings on which the rollers are disposed, a vanadium carbide layer formed on the cylindrical pin surfaces avoids abnormal wear elongation of the chain, and allows smooth articulation of the chain over a long period of time, even when the lubricating oil is in an extremely deteriorated condition due to oxidation.

### FIELD OF THE INVENTION

This invention relates to a roller chain of the kind used for power transmission mechanism in an automobile or industrial machine, and in a conveyor mechanism.

### BACKGROUND OF THE INVENTION

Metal roller chains have come into increasing use, instead of toothed belts, as power transmission media in automobiles because of the demand for high load capacity, high speed, and maintenance-free operation.

In conventional roller chain configuration, both ends of a cylindrical bushing are fixed to a pair of inner plates of the chain by fitting into bushing holes in the inner plates. A pin fits rotatably into, and extends through, the bushing. The ends of the pin are fixed to a pair of outer plates disposed outside the inner plates. A roller fits rotatably on the bushing.

In conventional roller chains, in order to obtain improved strength and avoidance of wear elongation, the pins have been subjected to heat treatment such as quench hardening/tempering, carburization hardening/carburization tempering or the like. In some roller chains, a chromium carbide layer is formed on the pin surface.

In spite of the heat treatment of the pins, and the formation of a chromium carbide layer on the surfaces of the pins in chains used as timing chains in automobile engines and the like, it has been reported that a small number of chains do not exhibit the expected wear resistance, and abnormal wear elongation occurs. Therefore, there was an urgent need to eliminate abnormal wear elongation in order to achieve an improvement in the reliability of the engine.

As a result of our continued study of this problem, we have found that the abnormal wear elongation of the roller chains is caused by the fact that lubricating oil in the engine becomes extremely deteriorated, and when the oxidation of the lubricating oil causes the pH of the oil to be less than 3, the pin surfaces become corroded by the lubricating oil, and wear of the pin surface is accelerated through sliding contact with its bushing. It has also become clear that powder generated by the wear of the pin surface exists as an inclusion between the pin and the bushing, causing further acceleration of wear by abrasion of the sliding contact surfaces of the pin and the bushing. It has also become clear that, when the pin and the bushing are made of materials having a high affinity for each other, both materials are liable to agglomerate, and the agglomeration of these materials causes further acceleration of wear.

Accordingly, the principal objects of this invention are to solve the above-described problems of conventional roller chains, and to provide a roller chain which does not exhibit abnormal wear elongation, and which articulates smoothly over a long period of time, even when lubricated by an extremely deteriorated oil having a high degree of oxidation.

In a roller chain in accordance with the invention, a pair of inner plates, having outwardly facing surfaces, are provided in side-by-side relationship, and two outer plates are disposed adjacent the outwardly facing surfaces of the inner plates. A cylindrical bushing has its ends fixed to bushing holes of the inner plates, and a pin having a cylindrical pin surface fits rotatably in the bushing, with its ends fixed to pin holes in the outer plates. A roller fits rotatably onto the bushing. The chain is characterized by a vanadium carbide layer formed on the cylindrical pin surfaces.

The vanadium carbide layer formed on the pin surfaces improves the corrosion resistance of the pins, allowing the chain to articulate smoothly over a long period of time without abnormal wear elongation, even in the low pH environment caused by deterioration of lubricating oil. Furthermore, since the vanadium carbide is formed on the pin surface, the affinity between the pin and the bushing is reduced, and agglomeration of particles resulting from wear of both the pin and the bushing is prevented.

### BRIEF DESCRIPTION OF THE DRAWINGS

FIG. 1 is an exploded perspective view showing a portion of a roller chain in accordance with the invention;

FIG. 2 is a graph showing the results of chain elongation tests, in oxidized, deteriorated oil, of conventional roller chains, and a roller chain according to invention;

FIG. 3 is a graph showing the results of chain elongation tests, in new oil, of conventional roller chains, and a roller chain according to invention; and

FIG. 4 is a graph showing the results of chain elongation tests, in soot-containing oil, of conventional roller chains, and a roller chain according to invention.

### DETAILED DESCRIPTION OF THE PREFERRED EMBODIMENTS

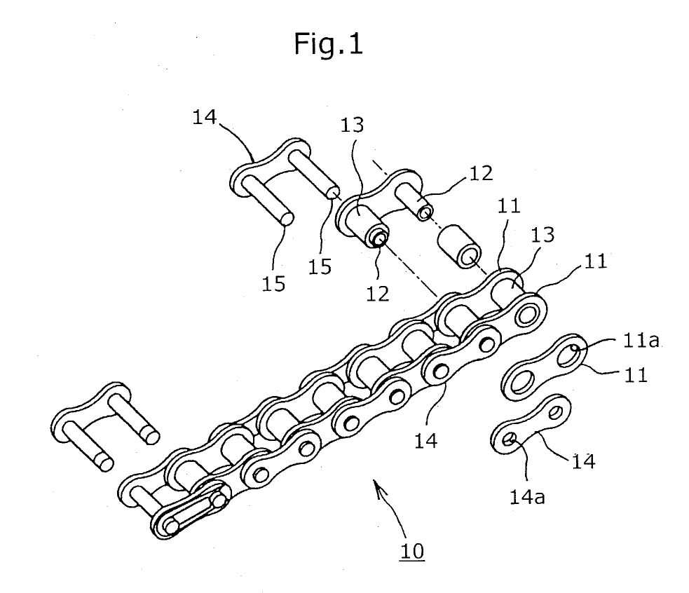

In FIG. 1, the assembled structure of a portion of the roller chain 10 is shown along with the individual parts of the chain. Both ends of a cylindrical bushing 12 are fixed to bushing holes 11a in a pair of inner plates 11. Pins 15 are inserted through the bushings 12, and rotatable therein. The ends of the pins are fixed to pin holes 14a in a pair of outer plates 14 disposed adjacent the outer sides of the pair of inner plates 11. A roller 13 is rotatably fitted onto the bushing 12.

In the roller chain of the invention, a hardened layer of vanadium carbide, having a thickness of 6 to 20 :m, is formed on the cylindrical surface of the pins. The pin is formed by the following process. First, a pin containing 0.1 to 0.4 wt % carbon, along with manganese and silicon, and further containing chromium, molybdenum, or both chromium and molybdenum, with the balance being iron and impurities, is subjected to carburization hardening to form a high-carbon surface layer having a carbon content of 0.7 to 1.0% on the surface layer of the material. Then, a hardened vanadium carbide layer is formed on the pin surface layer by a powder penetration process in which vanadium powder or vanadium alloy powder is added to the pin surface layer and subjected to heat treatment, at a high temperature in the range from 900E C to 1100E C, for 5 to 25 hours.

Alternatively, a chemical deposition process may be used. In chemical deposition, a thin film of vanadium carbide is formed on the pin surface by a melting penetration process using molten salt. A vapor phase chemical reaction may also be used for chemical deposition. Another method of forming the thin film of vanadium carbide on the pin is physical vapor deposition, in which vanadium is vaporized by a physical process such as high-temperature heating, sputtering, arc charging or the like, in order to cause vanadium to agglomerate on the pin surface.

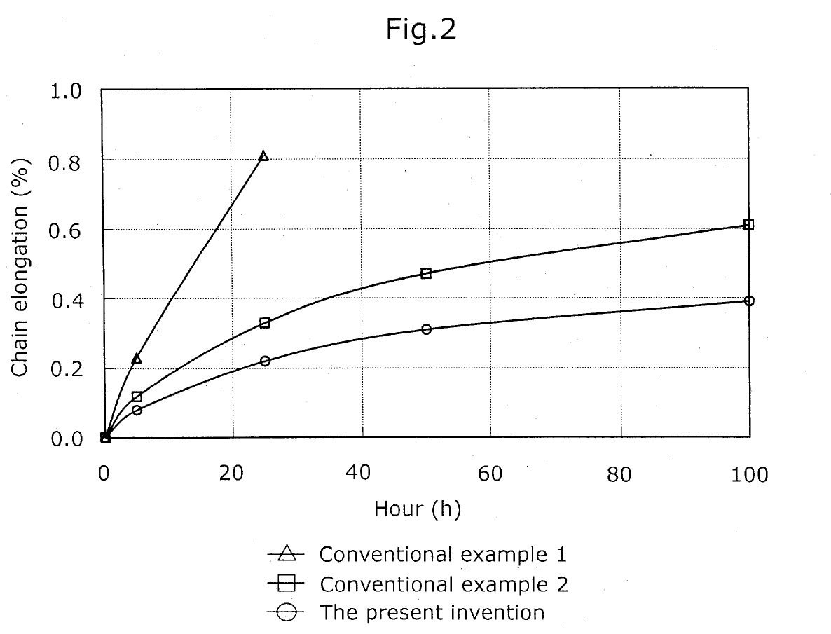

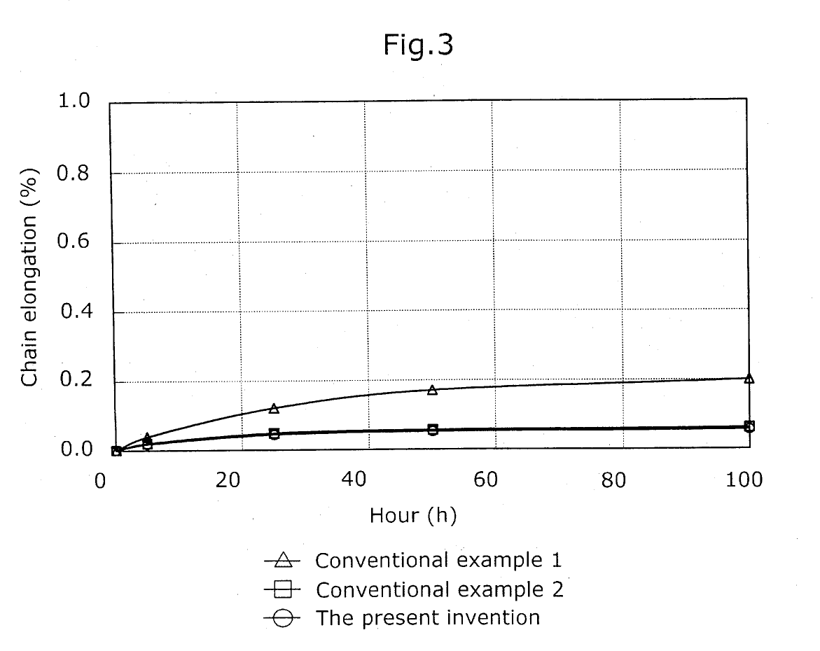

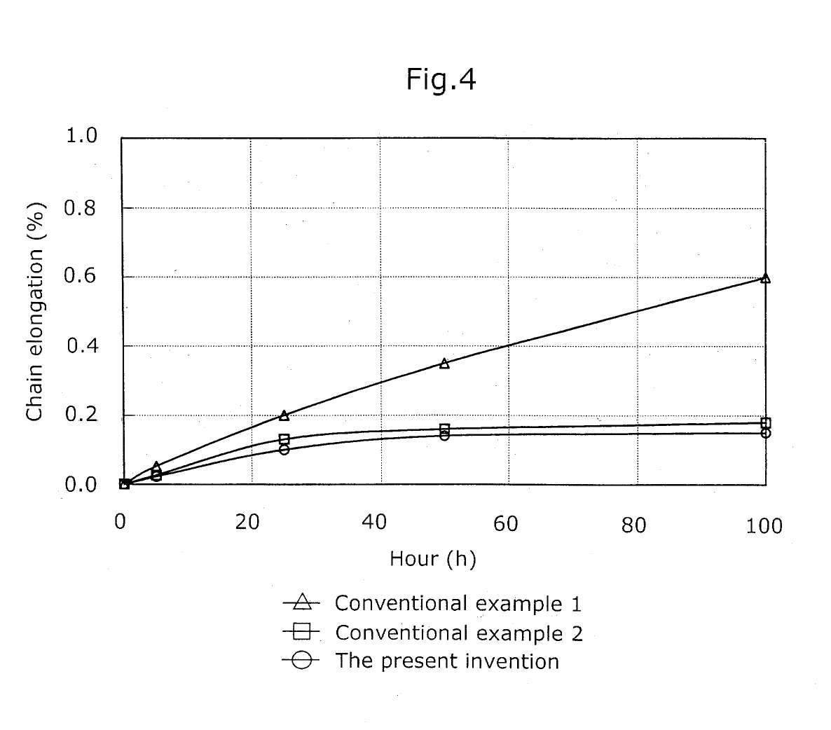

FIGS. 2 to 4 show the results of chain elongation tests, which were carried out in order to evaluate the wear resistance of the roller chain according to the invention, and to compare its wear resistance with the wear resistance of conventional roller chains. FIG. 2 shows the results of tests carried out on chains lubricated in oxidized, deteriorated oil. FIG. 3 shows the results of tests carried out on chains lubricated in new oil. FIG. 4 shows the results of tests carried out on chains lubricated by oil containing abrasive carbon soot as its principal contaminant. In conventional example 1 a carburized pin was used, and chromium carbide was formed on the surface of the pin of conventional example 2.

As shown in FIG. 3, in new oil, the elongation of the roller chain of the invention was about ⅓ the elongation of the chain of conventional example 1, having a carburized pin. However, the elongation of the roller chain of the invention in new oil was no better than that of conventional example 2, in which a pin having a surface layer of chromium carbide was used.

However, as shown in FIG. 2, in oxidized deteriorated oil, the elongation of the roller chain of the invention was about ⅔ the elongation of the chain of conventional example 2. Furthermore, as shown in FIG. 4, the elongation properties of the roller chain of the invention are superior to those of conventional examples 1 and 2 in soot-containing oil.

These test results lead to the conclusion that, in the roller chain of the invention, wear resistance in oxidized deteriorated oil is significantly improved, since vanadium carbide has corrosion resistance superior to that of chromium carbide in the deteriorated oil environment. Furthermore, since the roller chain pins having a vanadium carbide layer are harder than those subjected to carburization heat treatment and also harder than those having a chromium carbide layer, the wear resistance properties of the roller chain in accordance with the invention are superior in soot-containing oil.

Heretofore, surface treatment by the formation of a vanadium carbide layer was not recognized to be significantly advantageous as compared with other surface treatments such as carburization heat treatment and the formation of chromium carbide layer. However, vanadium carbide has proven to be highly superior as a coating material for the pins of a roller chain used under severe conditions such as in oxidized deteriorated oil or in soot-containing oil.

The vanadium carbide layer formed on the pin surfaces improves the corrosion resistance of the pins and dramatically improves their wear resistance properties in oxidized, deteriorated oil. As a result, excellent durability and reliability of the roller chain are achieved, and abnormal elongation of the chain is avoided over a long period of time. Consequently, noise, tooth jumping, and impaired performance due to increased wear elongation of the chain, are avoided.

Even if a foreign substance such as carbon or the like enters the lubricating oil, the roller chain articulates smoothly without abrasion. Furthermore, with the roller chain of the invention, the time between oil changes is increased, and a reduction in the cost of operation is made possible. Moreover, since a vanadium carbide layer can be formed by the same conventional production process used in forming a chromium carbide layer, there is no increase in the cost of production of the roller chain.

By way of summary, we have found that abnormal wear elongation of a roller chain is due to the oxidation and deterioration of the lubricating oil, and taking this observation into account, we have determined that vanadium carbide is the most suitable material for coating the surfaces of the pins of the roller chain. The invention has a high technical significance in industry, since it allows abnormal wear elongation to be reproducibly avoided.

We claim:

1. A roller chain comprising a pair of inner plates in side-by-side relationship and having outwardly facing surfaces, a pair of outer plates disposed adjacent said outwardly facing surfaces of the inner plates, a cylindrical bushing having ends fixed to bushing holes of the inner plates, a pin having a cylindrical pin surface, said pin rotatably fitting in said bushing and having ends fixed to pin holes in said outer plates, and a roller rotatably fitting onto said bushing, wherein a vanadium carbide layer is formed on said cylindrical pin surface.
